(19) United States
(12) Patent Application Publication
(10) Pub. No.: US 2017/0124876 A1
(43) Pub. Date: May 4, 2017

(54) ROADWAY HAZARD DETECTION AND WARNING SYSTEM

(71) Applicant: Sharon D. Rogers, Greenville, NC (US)

(72) Inventor: Sharon D. Rogers, Greenville, NC (US)

(21) Appl. No.: 14/925,393

(22) Filed: Oct. 28, 2015

(51) Int. Cl. G08G 1/16; G01C 21/36; G07C 5/00

(52) U.S. Cl. CPC G08G 1/166; G08G 1/164; G07C 5/008; G01C 21/3697; G08G 1/161

(57) ABSTRACT

A roadway hazard detection and warning system includes a hazard vehicle module, which is configured to be provided in a hazard vehicle such as an oversize vehicle (e.g., a semi-truck, a truck with an oversize load such as a mobile home, an agricultural vehicle, or the like). The roadway hazard detection and warning system further includes a standard vehicle module, which is configured to be provided in a standard vehicle (e.g., a standard size car, truck, motorcycle, or the like). The hazard vehicle module and the standard vehicle module communicate to facilitate warnings to a driver of the standard vehicle in order to prevent accidents between the hazard vehicle and the standard vehicle.

### FIELD OF THE DISCLOSURE

The present disclosure relates to the detection and prevention of roadway hazards due to oversize or otherwise hazardous vehicles.

### BACKGROUND

The present disclosure relates to systems and methods to prevent or reduce collisions between routine or standard roadway vehicles and vehicles posing a roadway hazard (e.g., oversize vehicles, vehicles with oversize attachments or loads, or slow-moving oversize vehicles). Oversize vehicles such as those involved in agricultural, trucking, and mobile-home transportation industries pose substantial risk of road-related accidents to other vehicles, particularly in blind curves and rural or mountainous settings. Not all states' highway safety laws require guide vehicles (which lead and/or trail an oversize vehicle to warn other vehicles on the road of its presence). Even despite laws and business standards dictating the use of a guide vehicle, many oversize vehicles travel without such support. Further, agricultural vehicles utilize roadways almost exclusively without guide vehicles, as requiring such support is generally impractical for these vehicles. Drivers traveling at posted speeds, potentially distracted due to technology, enter curves unsuspecting of an encounter with an oversize vehicle, which is often slow-moving. These unfortunate encounters can occur when traveling in opposite directions (resulting in a head-to-head impact) or the same direction (resulting in a rear impact) with the oversize vehicle.

Previous roadway hazard detection and warning systems have focused on detecting hazards due to vehicles drifting across lanes, stopped emergency vehicles, and vehicles involved in services, repairs, or public utilities. Generally, these systems do not address the hazard that oversize vehicles present on the road. Accordingly, there is a need for a roadway hazard detection and warning system capable of detecting hazards due to oversize vehicles and alerting other drivers in order to prevent accidents related thereto.

### SUMMARY

In one embodiment, a roadway hazard detection and warning system includes a hazard vehicle module, which is configured to be provided in a hazard vehicle such as an oversize vehicle (e.g., a semi-truck, a truck with an oversize load such as a mobile home, an agricultural vehicle, or the like). The hazard vehicle module may be integrated into the hazard vehicle's infrastructure or may be portable and thus transferrable between hazard vehicles. The roadway hazard detection and warning system further includes a standard vehicle module, which may be integrated into or otherwise provided in a standard vehicle (e.g., a standard sized car, truck, or motorcycle). The standard vehicle module may be integrated into the infrastructure of the standard vehicle or may be portable and thus transferrable between standard vehicles. The standard vehicle module may include a hazard indicator such as a light, a screen, a speaker, some combination thereof, or the like, which may be activated when a hazard is detected by the standard vehicle module. The standard vehicle module may alternatively or additionally be implemented in an application running on a personal electronic device such as a smartphone, a smartwatch, or the like. The hazard vehicle module is configured to continuously provide information about the hazard vehicle, either directly to one or more standard vehicle modules or to a different location such as a server. For example, the hazard vehicle module may continuously broadcast the location of the hazard vehicle as global positioning system (GPS) coordinates. Such a broadcast may occur locally in an area around the hazard vehicle or may be facilitated by a larger communications network such as a cellular communications network, a satellite communications network, or the like. The standard vehicle module is configured to receive the broadcasts of the hazard vehicle module, either directly or indirectly. Accordingly, the standard vehicle module may provide an alert indicating information about the hazard vehicle such as location or distance, direction of travel, and/or the nature of the hazard such as the size of the hazard vehicle. Communication between the hazard vehicle module and standard vehicle module may occur directly or via an intermediary device such as a satellite or cellular communications base station.

The roadway hazard detection and warning system may also be applied to other vehicles known to cause hazards such as stopped emergency vehicles, vehicles involved with services, repairs, public utilities, or the like.

Those skilled in the art will appreciate the scope of the present disclosure and realize additional aspects thereof after reading the following detailed description in association with the accompanying drawings.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows a roadway hazard detection and warning system according to one embodiment of the present disclosure.

FIG. 2 shows a roadway hazard detection and warning system according to one embodiment of the present disclosure.

FIG. 3 is a call-flow diagram illustrating a communication flow in a roadway hazard detection and warning system according to one embodiment of the present disclosure.

FIG. 4 is a call-flow diagram illustrating a communication flow in a roadway hazard detection and warning system according to one embodiment of the present disclosure.

FIG. 5 is a call-flow diagram illustrating a communication flow in a roadway hazard detection and warning system according to one embodiment of the present disclosure.

FIG. 6 is a call-flow diagram illustrating a communication flow in a roadway hazard detection and warning system according to one embodiment of the present disclosure.

FIG. 7 is a call-flow diagram illustrating a communication flow in a roadway hazard detection and warning system according to one embodiment of the present disclosure.

FIG. 8 is a call-flow diagram illustrating a communication flow in a roadway hazard detection and warning system according to one embodiment of the present disclosure.

FIG. 9 illustrates a roadway hazard indicator according to one embodiment of the present disclosure.

FIG. 10 illustrates a user interface for a roadway hazard detection and warning system according to one embodiment of the present disclosure.

FIG. 11 illustrates a user interface for a roadway hazard detection and warning system according to one embodiment of the present disclosure.

FIG. 12 illustrates a user interface for a roadway hazard detection and warning system according to one embodiment of the present disclosure.

FIG. 13 is a block diagram of a roadway hazard detection and warning system according to one embodiment of the present disclosure.

FIG. 14 is a block diagram of a roadway hazard detection and warning system according to one embodiment of the present disclosure.

FIG. 15 is a block diagram of a server for use with a roadway hazard detection and warning system according to one embodiment of the present disclosure.

### DETAILED DESCRIPTION

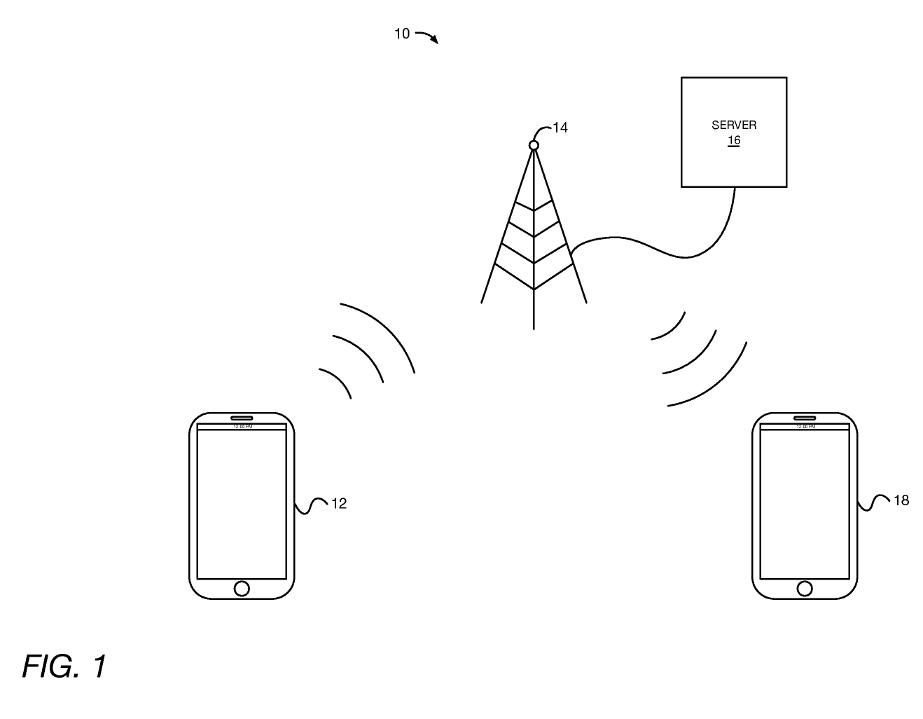

Turning now to FIG. 1, a roadway hazard detection and warning system 10 is shown according to one embodiment of the present disclosure. The roadway hazard detection and warning system 10 includes a hazard vehicle module 12, a communications relay 14, a server 16, and a standard vehicle module 18. In general, the hazard vehicle module 12 is configured to be placed and used in a hazard vehicle, such as an oversize truck, agricultural vehicle, emergency services vehicle, or the like. In some embodiments, the hazard vehicle module 12 may be a personal electronic device. Accordingly, the roadway hazard detection and warning system 10 may be implemented using devices that most individuals already own and operate. In other embodiments, the hazard vehicle module 12 may be specialized equipment that is integrated into a hazard vehicle. The communications relay 14 may be a cellular communications network. In other embodiments, the communications relay 14 may be any suitable wireless or wired communications network suitable to facilitate communication between the hazard vehicle module 12 and the standard vehicle module 18. The server 16 may be any general purpose computing platform suitable to perform the functions outlined below. Similar to the hazard vehicle module 12, the standard vehicle module 18 may also be a personal electronic device. Due to the already widespread usage of such devices, the roadway hazard detections system 10 may experience better utilization by users, and therefore prevent more accidents from occurring. The standard vehicle module 18 is configured to be placed and used in a standard vehicle, such as a standard sized car, truck, motorcycle, or the like. In some embodiments, the standard vehicle module 18 may be specialized hardware that is integrated into a standard vehicle. Further, the standard vehicle module 18 may be integrated into a fixed hazard warning indicator (not shown) as discussed below.

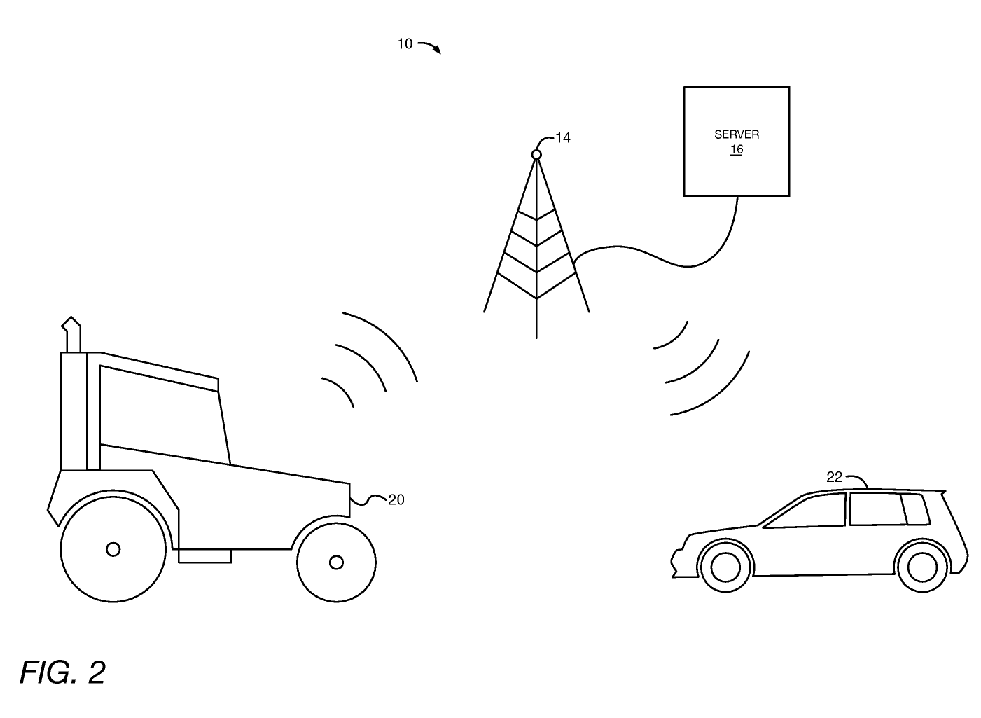

FIG. 2 shows the roadway hazard detection and warning system 10 according to an additional embodiment of the present disclosure. The roadway hazard detection and warning system 10 in FIG. 2 is substantially similar to that shown in FIG. 1, except that the hazard vehicle module 12 and the standard vehicle module 18 are placed or otherwise integrated into a hazard vehicle 20 (shown as an agricultural vehicle) and a standard vehicle 22, respectively. As discussed above, the hazard vehicle module 12 and the standard vehicle module 18 may be personal electronic devices that are used within the respective vehicles or may comprise specialized hardware that is integrated into the vehicles.

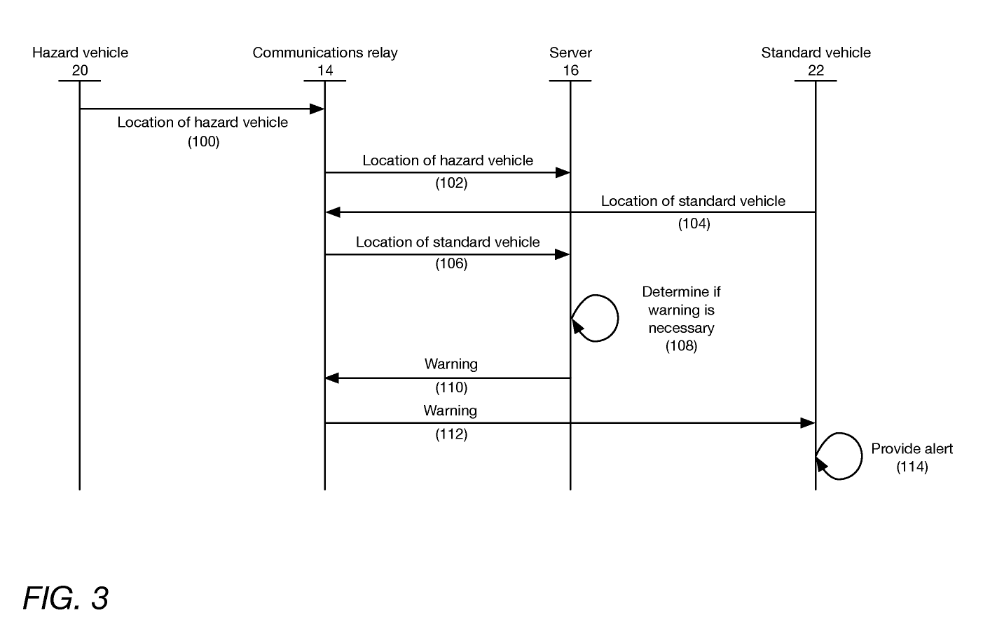

FIG. 3 is a call-flow diagram illustrating an exemplary communications exchange in the roadway hazard detection and warning system 10. First, a location of the hazard vehicle 20 is sent to the communications relay 14 via the hazard vehicle module 12 (step 100). The communications relay 14 then forwards the location of the hazard vehicle 20 to the server 16 (step 102). In some embodiments, the hazard vehicle 20 may be global positioning system (GPS) coordinates, however, any suitable location designators may be used without departing from the principles described herein. Similarly, the standard vehicle 22 sends its location to the communications relay 14 via the standard vehicle module 18 (step 104). Again, the location of the standard vehicle 22 may be GPS coordinates or any other suitable location designator. The communications relay 14 then forwards the location of the standard vehicle 22 to the server 16 (step 106). The server 16 may then determine if a warning is necessary (step 108). This may include determining the distance between the hazard vehicle 20 and the standard vehicle 22 (e.g., by performing a calculation on their respective GPS coordinates), determining if the hazard vehicle 20 and or the standard vehicle 22 are near a known obstacle, such as foliage or blind curves that may obstruct a view of the hazard vehicle 20 or the standard vehicle 22, or the like. If a warning is required, the server 16 sends a warning to the communications relay 14 (step 110), which then forwards the warning to the standard vehicle 22 (step 112). The standard vehicle 22 may then provide an alert (114), such as an audible alert, a visual alert, a haptic alert, or some combination thereof.

As discussed above, determining if a warning is necessary may involve determining if the hazard vehicle 20, the standard vehicle 22, or both are near a known obstacle, such as foliage that may obstruct a view of the hazard vehicle 20 or the standard vehicle 22. In some embodiments, the hazard vehicle module 12, the standard vehicle module 18, or both allow a user to report these obstacles to the server 16, which may store the location of said obstacles in a database or other suitable storage mechanism. In other embodiments, satellite imagery, topological data, or any other suitable geospatial data may be used to determine potential obstacles.

Notably, as discussed herein, the portions of the communication flow attributed to the hazard vehicle 20 and the standard vehicle may actual be accomplished by the hazard vehicle module 12 and the standard vehicle module 18, respectively, which are provided within these vehicles.

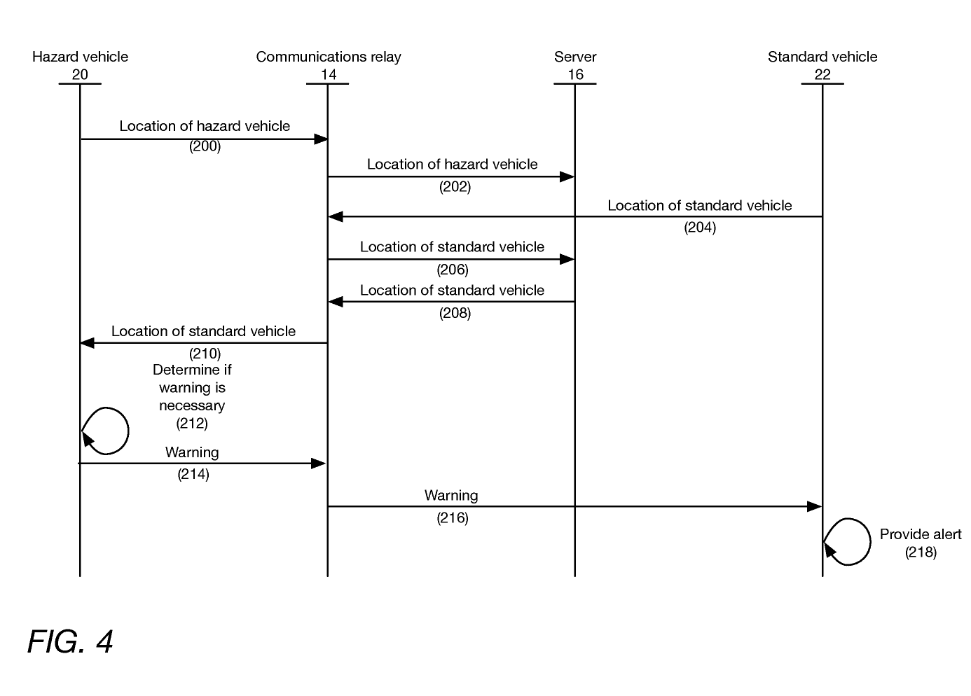

FIG. 4 shows a call-flow diagram illustrating an exemplary communications exchange in the roadway hazard detection and warning system 10 according to an additional embodiment of the present disclosure. The communications exchange shown in FIG. 4 is substantially similar to that shown in FIG. 3, with steps 200-206 being the same as steps 100-106. However, in the communications exchange shown in FIG. 4, the server does not determine if a warning is necessary. Instead, the server sends the location of the standard vehicle 22 to the communications relay 14 (step 208), which in turn forwards the location of the standard vehicle 22 to the hazard vehicle 20 (step 210). The hazard vehicle 20 then determines if a warning is necessary as discussed above (step 212). If a warning is necessary, the hazard vehicle 20 sends a warning to the communications relay 14 (step 214), which in turn forwards the warning to the standard vehicle 22 (step 216). The standard vehicle 22 may then provide an alert as discussed above (step 218).

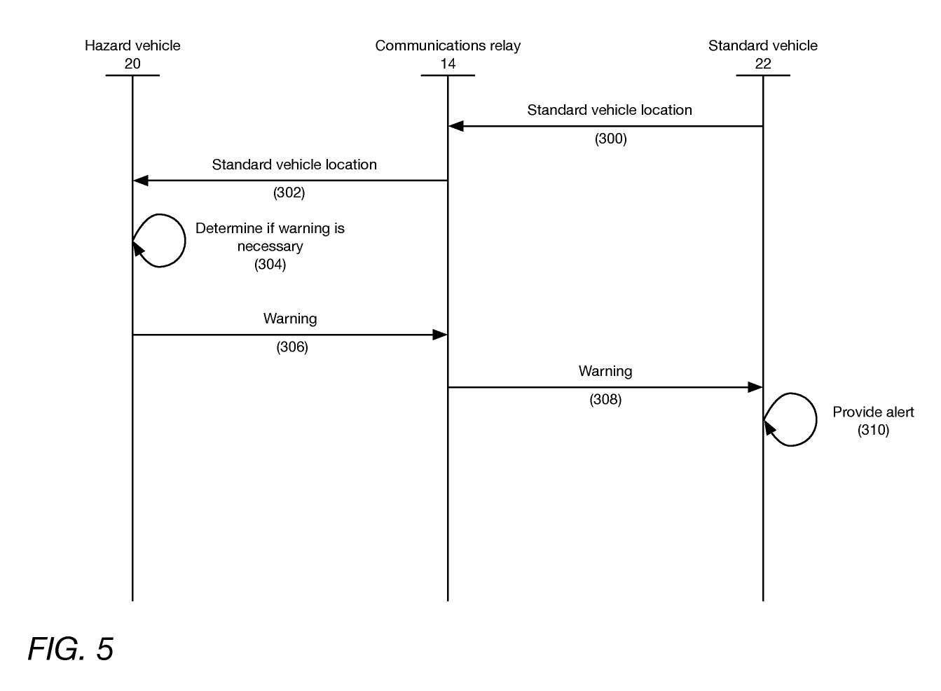

FIG. 5 shows a call-flow diagram illustrating an exemplary communications exchange in the roadway hazard detection and warning system 10 according to an additional embodiment of the present disclosure. Notably, FIG. 5 shows a communications exchange in which the server 16 is not used. First, the standard vehicle 22 sends its location to the communications relay 14 via the standard vehicle module 18 (step 300). The communications relay 14 then forwards the location of the standard vehicle 22 to the hazard vehicle 20 (step 302). The hazard vehicle 20 then determines if a warning is necessary as described above (step 304). If a warning is necessary, the warning is sent to the communications relay 14 (step 306), which then forwards the warning to the standard vehicle 22 (step 308). The standard vehicle 22 may then provide an alert as discussed above (step 310).

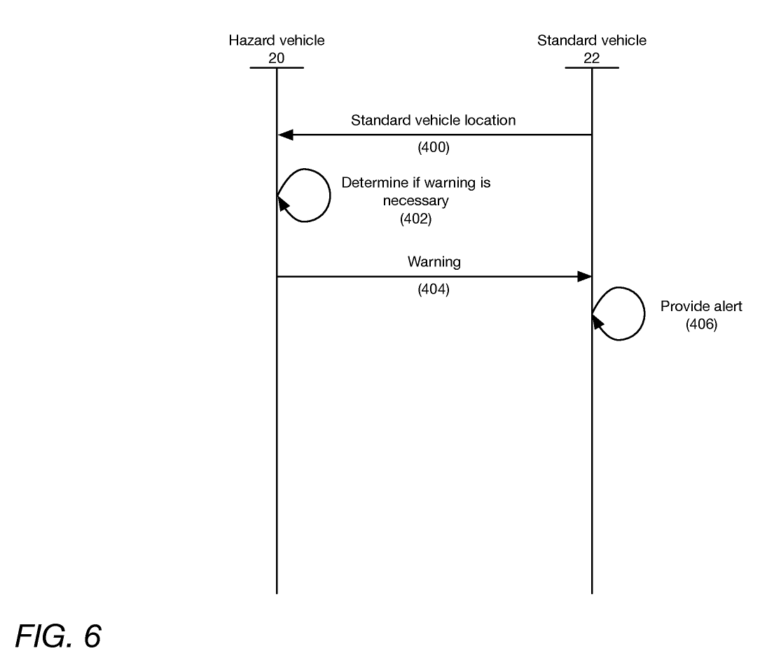

FIG. 6 shows a call-flow diagram illustrating an exemplary communications exchange in the roadway hazard detection and warning system 10 according to an additional embodiment of the present disclosure. Notably, FIG. 6 shows a communications exchange in which neither the communications relay 14 nor the server 16 are used. First, the standard vehicle 22 sends its location to the hazard vehicle 20 via the standard vehicle module 18 (step 400). In this embodiment, the standard vehicle 22 may not send its location directly, but rather may broadcast its location or some other signal indicating its proximity within a predefined radius of the vehicle. Accordingly, receiving the signal may indicate that the standard vehicle 22 is within a predefined distance of the hazard vehicle 20 and thus should be warned of its presence. The hazard vehicle 20 then determines if a warning is necessary (step 402). As discussed above, a warning may be issued if the signal from the standard vehicle 22 is received at all. If a warning is necessary, it is sent from the hazard vehicle 20 directly to the standard vehicle 22 via the hazard vehicle module 12 (step 404). The standard vehicle 22 may then provide an alert as discussed above (step 406). Notably, steps 400 and 402 may be omitted completely, such that the hazard vehicle 20 is constantly broadcasting a warning signal. The standard vehicle 22 may thus be constantly listening for a warning signal via the standard vehicle module 18. Because the warning signal from the hazard vehicle 20 may only be broadcast within a predefined distance from the hazard vehicle, only those standard vehicles 22 that are nearby will receive the warning signal.

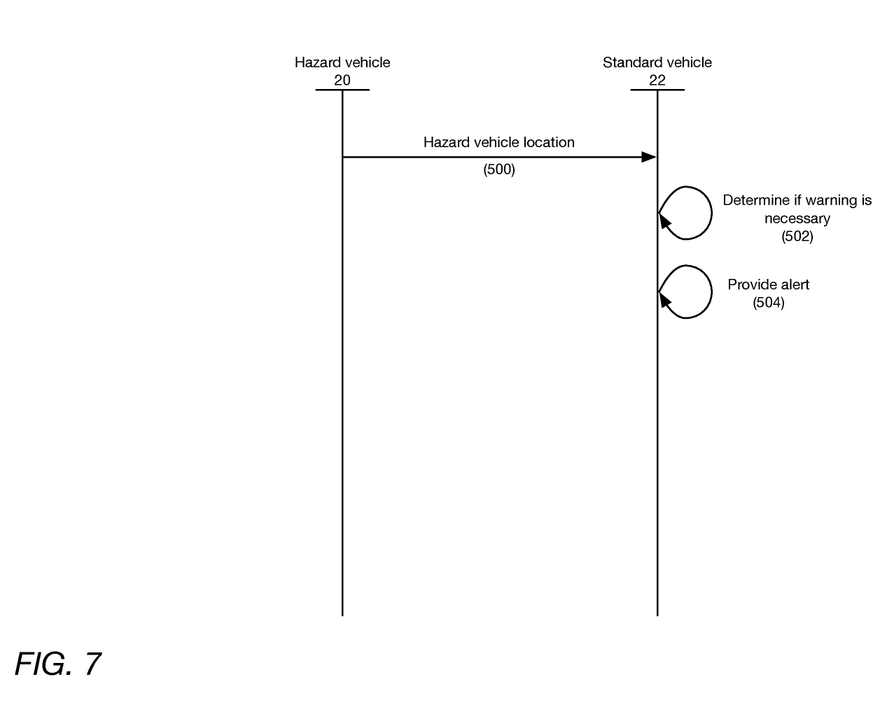

FIG. 7 shows a call-flow diagram illustrating an exemplary communications exchange according to an additional embodiment of the present disclosure. First, the hazard vehicle 20 providing its location to the standard vehicle 22 (step 500). The standard vehicle 22 then determines if a warning is necessary (step 502). This may be based on the location of the hazard vehicle, the location of one or more obstacles, and/or the location of the standard vehicle as discussed above. The standard vehicle 22 may then provide an alert as discussed above (step 504).

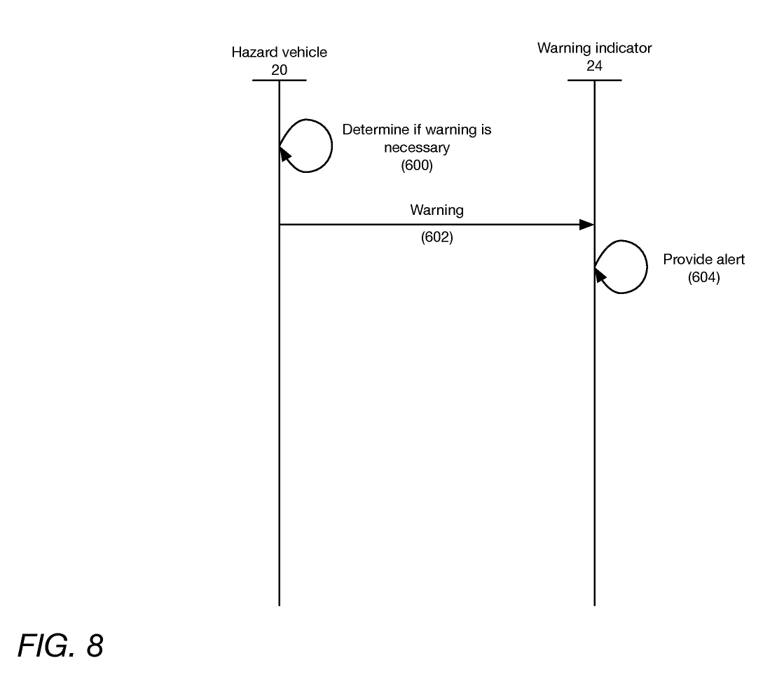

FIG. 8 shows a call-flow diagram illustrating an exemplary communications exchange according to an additional embodiment of the present disclosure. Notably, FIG. 8 shows a communications exchange between the hazard vehicle 20 and a hazard warning indicator 24. First, the hazard vehicle 20 determines if a warning is necessary (step 600). In the present embodiment, this may comprise determining the proximity of the hazard vehicle 20 to one or more known obstacles, or to the hazard warning indicator 24. If a warning is necessary, the hazard vehicle 20 sends a warning signal to the hazard warning indicator 24 (step 602). Notably, while not shown, this warning signal may be sent via the communications relay 14. The hazard warning indicator 24 may then provide an alert as discussed above (step 604).

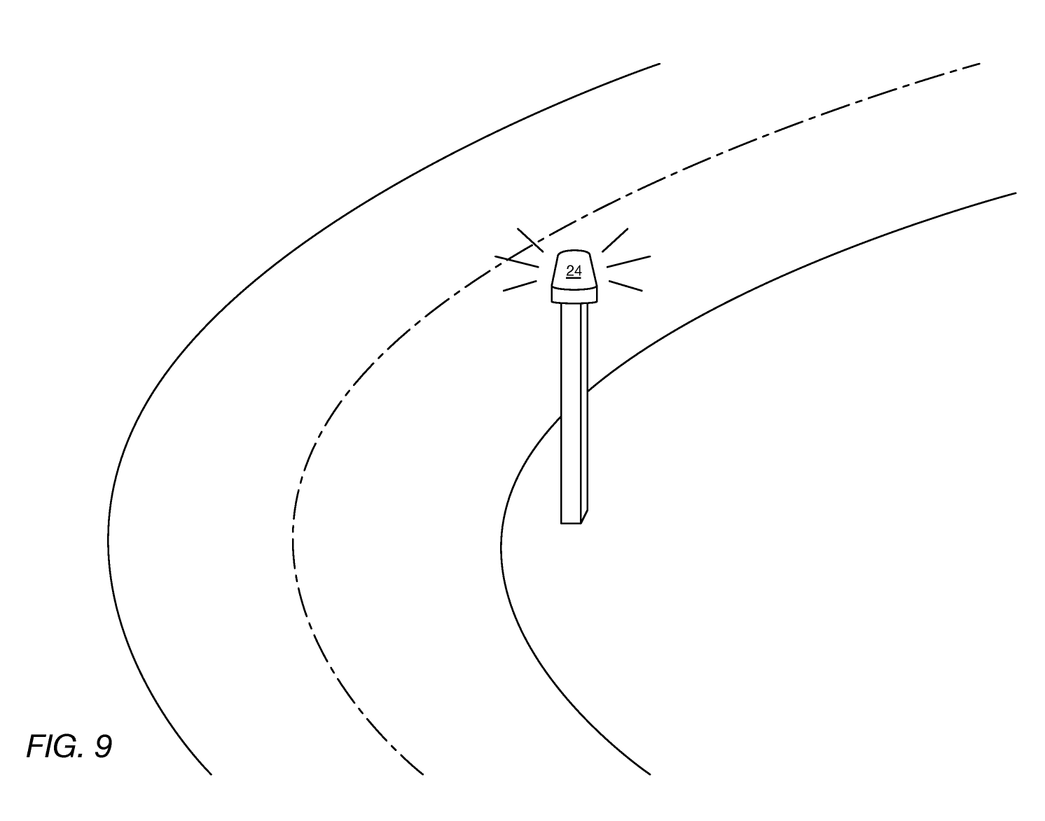

FIG. 9 shows an exemplary hazard warning indicator 24. The hazard warning indicator 24 may be, for example, a warning indicator light that is strategically placed near an obstacle. In the example shown in FIG. 9, the hazard warning indicator 24 is placed near a curve, which may be a blind curve. When the hazard vehicle is near the hazard warning indicator 24 and thus the curve, the hazard warning indicator 24 may indicate the presence of the hazard vehicle 20. Accordingly, drivers of standard vehicles 22 will be alerted to the presence of the hazard vehicle 20. While the hazard warning indicator 24 requires additional setup and placement, it protects drivers of standard vehicles 22 that may fail to see an alert presented on the standard vehicle module 18 or do not own a standard vehicle module 18. Since many agricultural vehicles often drive the same or similar routes, and obstacles in the path of the agricultural vehicle are often well known to the driver, strategically placing hazard warning indicators 24 at or near these obstacles may prevent or reduce the prevalence of accidents with other drivers.

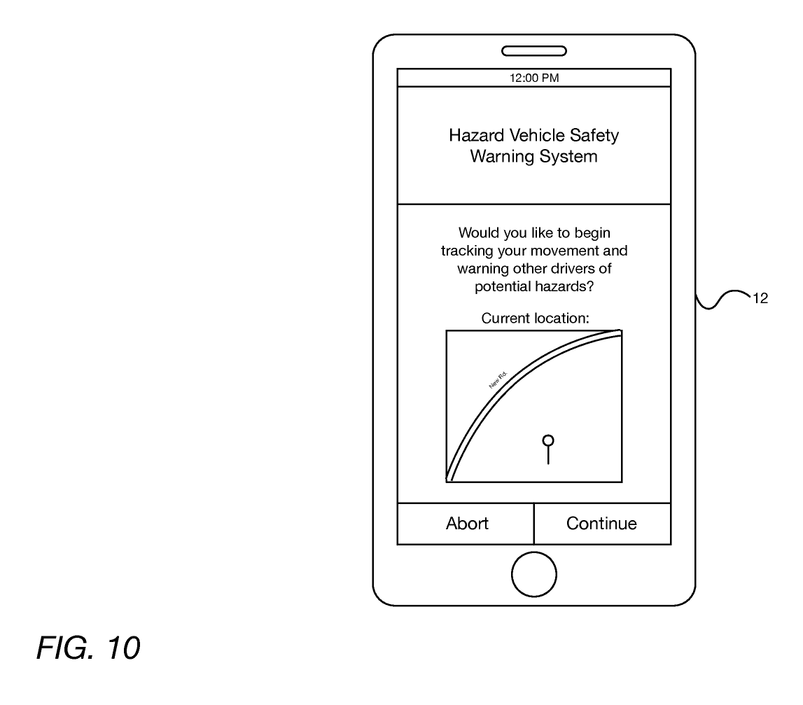

As discussed above, the hazard vehicle module 12 may be a personal electronic device such as a smartphone. Accordingly, the hazard vehicle module 12 may be implemented in software and utilize the built-in hardware of the device to perform its various functions. FIG. 10 thus shows an exemplary user interface that may be presented to the driver of the hazard vehicle 20 before driving. As shown, the device asks the driver of the hazard vehicle 20 if they would like to begin warning other drivers of potential hazards that may be presented by the hazard vehicle 20. As discussed above, the location of the hazard vehicle 20 may be shared with the server 16, the standard vehicle module 18, or any other devices in order to effectuate said warnings.

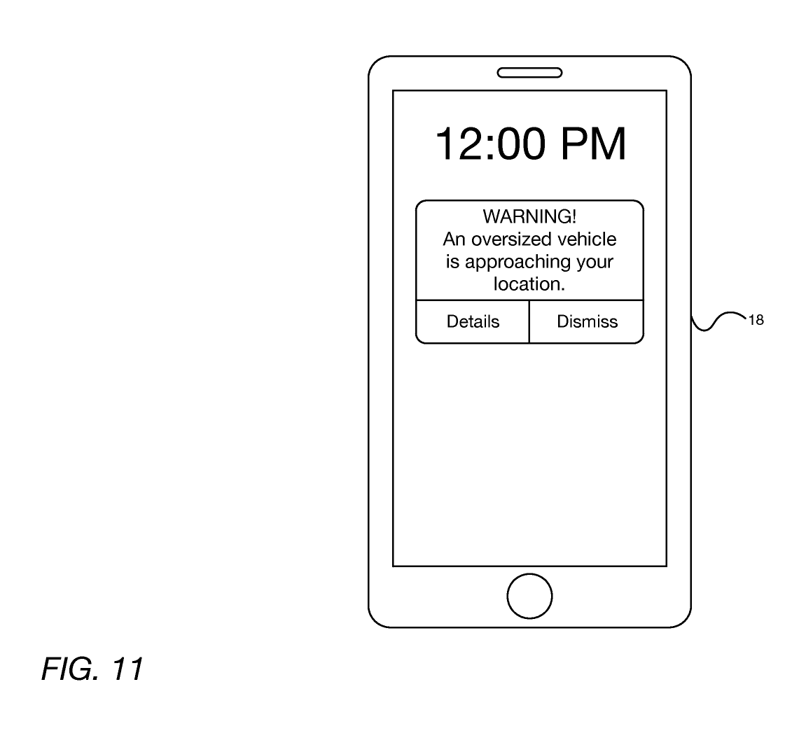

FIG. 11 shows an exemplary user interface that may be presented to a driver of a standard vehicle 22. As shown, a pop-up warning message indicating the presence of a nearby oversize vehicle is presented, with options to dismiss or view details about the warning. Notably, said warning may be presented via an emergency broadcast system that is implemented in many popular mobile operating systems such as iOS and Android, such that users are not required to opt-in to these alerts by downloading an application. Accordingly, a larger number of drivers may be warned about potential hazardous vehicles and thus avoid accidents. However, push notifications or any other suitable notifications from a mobile application may also be used without departing from the principles of the present disclosure.

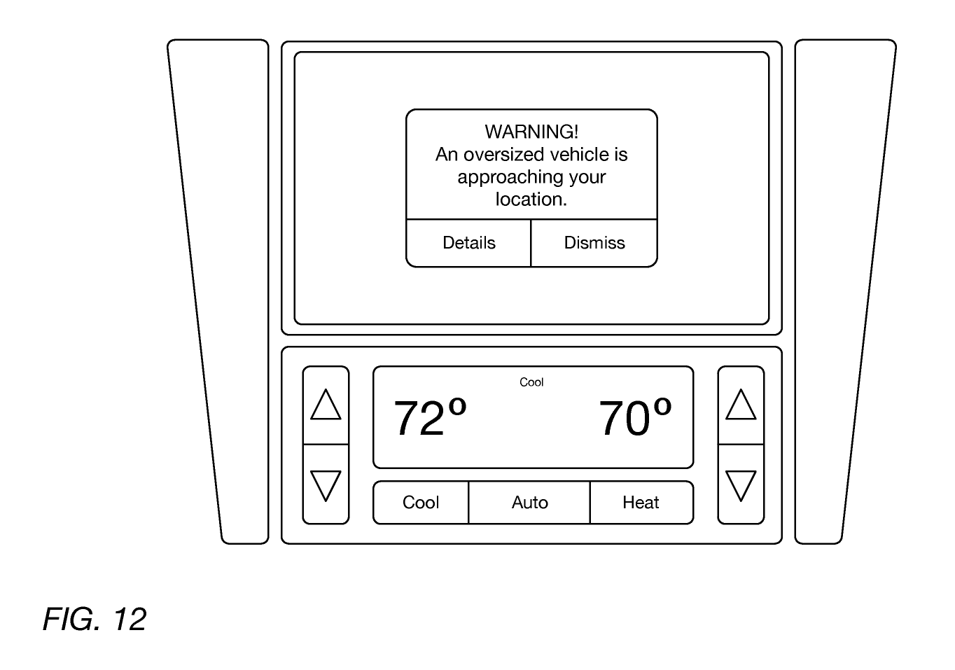

FIG. 12 shows an exemplary user interface that may be presented to a driver of a standard vehicle 22 via built-in hardware in the vehicle. The warning presented in FIG. 12 is substantially similar to that shown in FIG. 11, except that it is presented on hardware built into the standard vehicle 22. While an alert on a screen is shown, any other suitable warning mechanism such as an indicator light, an indicator speaker, or the like may similarly be used without departing from the principles of the present disclosure.

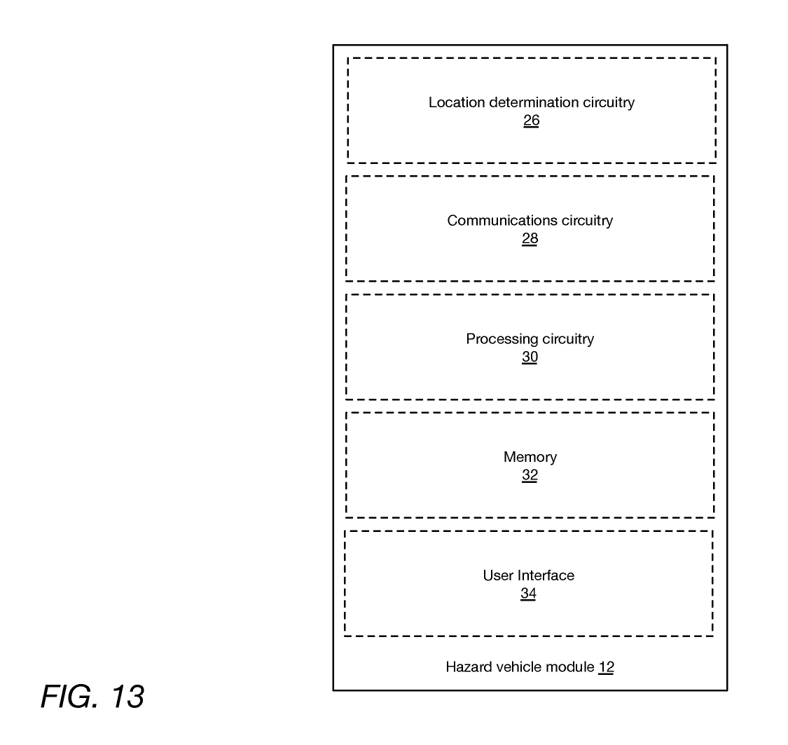

FIG. 13 is a block diagram showing details of the hazard vehicle module 12 according to one embodiment of the present disclosure. As shown in FIG. 13, the hazard vehicle module 12 includes location determination circuitry 26, communications circuitry 28, processing circuitry 30, a memory 32, and a user interface 34. The memory 32 may store instructions, which, when executed by the processing circuitry 30 allow the hazard vehicle module 12 and/or standard vehicle module 18 to effectuate the functionality described above. The location determination circuitry 26 allows the hazard vehicle module 12 to determine a location of the hazard vehicle in which it is provided. The communications circuitry 28 allows for communication between the hazard vehicle module 12 and any other devices such as the standard vehicle module 18, the communications relay 14, and the server 16. The user interface 34 may allow for user input to start and/or stop software that is stored in the memory for effectuating the functionality described above. Further, the user interface 34 may allow for input regarding the location of potential obstacles or hazardous areas, which may be taken into account when determining when to provide a warning signal to one or more standard vehicles as discussed above.

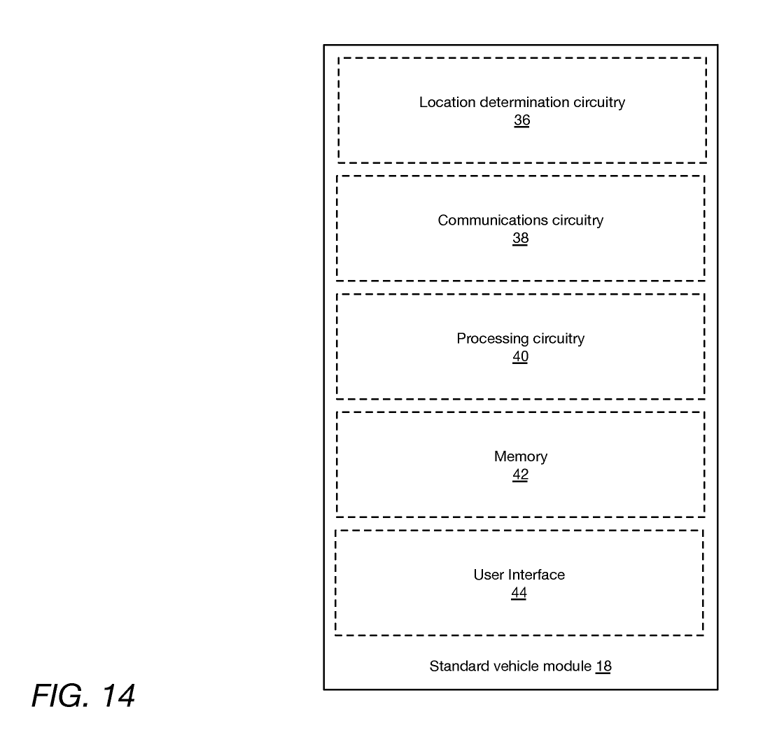

FIG. 14 is a block diagram showing details of the standard vehicle module 18 according to one embodiment of the present disclosure. As shown in FIG. 14, the standard vehicle module 18 includes location determination circuitry 36, communications circuitry 38, processing circuitry 40, a memory 42, and a user interface 44. The memory 42 may store instructions, which, when executed by the processing circuitry 40 allow the hazard vehicle module 12 and/or standard vehicle module 18 to effectuate the functionality described above. The location determination circuitry 36 allows the hazard vehicle module 12 to determine a location of the hazard vehicle in which it is provided. The communications circuitry 38 allows for communication between the hazard vehicle module 12 and any other devices such as the standard vehicle module 18, the communications relay 14, and the server 16. The user interface 44 may allow for user input to start and/or stop software that is stored in the memory for effectuating the functionality described above. Further, the user interface 44 may allow for input regarding the location of potential obstacles or hazardous areas, which may be taken into account when determining when to provide a warning signal to one or more standard vehicles as discussed above.

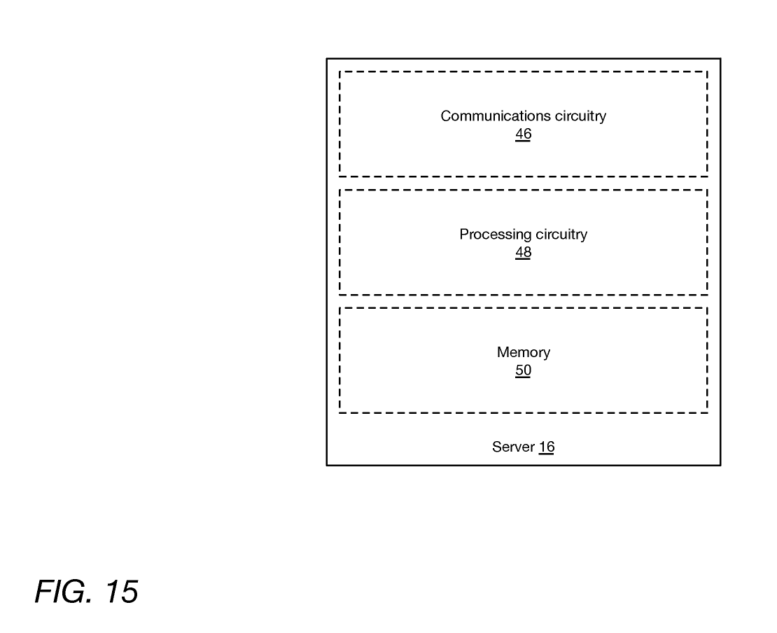

FIG. 15 is a block diagram showing details of the server 16 according to one embodiment of the present disclosure. As shown in FIG. 15, the server 16 includes communications circuitry 46, processing circuitry 48, and a memory 50. The memory 50 may store instructions, which, when executed by the processing circuitry 48 allow the server 16 to effectuate the functionality described above. The communications circuitry 46 allows the server 16 to communicate with the hazard vehicle module 12, the communications relay 14, the standard vehicle module 18, and any other necessary devices.

Those skilled in the art will recognize improvements and modifications to the present disclosure. All such improvements and modifications are considered within the scope of the concepts disclosed herein.

What is claimed is:

1. A roadway hazard detection and warning system comprising:
communications circuitry;
processing circuitry coupled to the communications circuitry; and
a memory coupled to the processing circuitry and storing instructions, which, when executed by the processing circuitry cause the roadway hazard detection and warning system to:
receive a location of a hazard vehicle via the communications circuitry; and
determine if a warning signal should be provided to one or more standard vehicles based on the location of the hazard vehicle.

2. The roadway hazard detection and warning system of claim 1 wherein determining if the warning signal should be provided comprises determining if the hazard vehicle is within a predefined obstacle hazard distance of one or more obstacles that may obscure the hazard vehicle from view of the one or more standard vehicles.

3. The roadway hazard detection and warning system of claim 2 wherein the roadway hazard detection and warning system is further configured to receive a location of the one or more obstacles.

4. The roadway hazard detection and warning system of claim 2 wherein the memory stores further instructions, which, when executed by the processing circuitry cause the roadway hazard detection and warning system to provide the warning signal to the one or more standard vehicles if the hazard vehicle is within the predefined obstacle hazard distance of the one or more obstacles.

5. The roadway hazard detection and warning system of claim 1 wherein the memory stores further instructions, which, when executed by the processing circuitry, cause the roadway hazard detection and warning system to receive location information about the one or more standard vehicles.

6. The roadway hazard detection and warning system of claim 5 wherein determining if the warning signal should be provided further comprises determining if the one or more standard vehicles are within a predefined vehicle hazard distance of the hazard vehicle.

7. The roadway hazard detection and warning system of claim 6 wherein the memory stores further instructions, which, when executed by the processing circuitry cause the roadway hazard detection and warning system to provide the warning signal to the one or more standard vehicles that are within the predefined vehicle hazard distance of the hazard vehicle.

8. The roadway hazard detection and warning system of claim 5 wherein determining if the warning signal should be provided further comprises determining if the hazard vehicle is within a predefined obstacle hazard distance of one or more obstacles that may obscure the hazard vehicle from view of the one or more standard vehicles.

9. The roadway hazard detection and warning system of claim 8 wherein the roadway hazard detection and warning system is further configured to receive a location of the one or more obstacles.

10. The roadway hazard detection and warning system of claim 8 wherein the memory stores further instructions, which, when executed by the processing circuitry cause the roadway hazard detection and warning system to provide the warning signal to the one or more standard vehicles that are within the predefined vehicle hazard distance of the hazard vehicle if the hazard vehicle is within the predefined obstacle hazard distance of the one or more obstacles.

11. A roadway hazard detection and warning module configured to be provided in a hazard vehicle and comprising:
location determination circuitry;
communications circuitry;
processing circuitry coupled to the communications circuitry and the location determination circuitry; and
a memory coupled to the processing circuitry and storing instructions, which, when executed by the processing circuitry cause the roadway hazard detection and warning module to:
determine a location of the hazard vehicle via the location determination circuitry; and
determine if a warning signal should be provided to one or more standard vehicles based on the location of the hazard vehicle.

12. The roadway hazard detection and warning module of claim 11 wherein the memory stores further instructions, which, when executed by the processing circuitry cause the roadway hazard detection and warning module to receive location information about the one or more standard vehicles.

13. The roadway hazard detection and warning module of claim 12 wherein determining if the warning signal should be provided to the one or more standard vehicles comprises determining if the one or more standard vehicles are within a predefined vehicle hazard distance of the hazard vehicle.

14. The roadway hazard detection and warning module of claim 13 wherein the memory stores further instructions, which, when executed by the processing circuitry cause the roadway hazard detection and warning module to provide the warning signal to the one or more standard vehicles that are within the predefined vehicle hazard distance of the hazard vehicle.

15. The roadway hazard detection and warning module of claim 11 wherein determining if the warning signal should be provided to the one or more standard vehicles further comprises determining if the hazard vehicle is within a predefined obstacle hazard distance of one or more obstacles that may obscure the hazard vehicle from view of the one or more standard vehicles.

16. The roadway hazard detection and warning module of claim 15 wherein the memory stores further instructions, which, when executed by the processing circuitry cause the roadway hazard detection and warning module to receive a location of the one or more obstacles.

17. The roadway hazard detection and warning module of claim 15 wherein the memory stores further instructions, which, when executed by the processing circuitry cause the roadway hazard detection and warning module to provide the warning signal to the one or more standard vehicles if the hazard vehicle is within the predefined obstacle hazard distance of the one or more obstacles.

18. A roadway hazard detection and warning module configured to be provided in a standard vehicle comprising:
location determination circuitry;
communications circuitry;
processing circuitry coupled to the location determination circuitry and the communications circuitry; and
a memory storing instructions, which, when executed by the processing circuitry cause the roadway hazard detection and warning module to:
determine a location of the standard vehicle via the location determination circuitry;
receive location information about one or more hazard vehicles via the communications circuitry; and
determine if an alert should be provided based on the location of the standard vehicle and the location information about the one or more hazard vehicles.

19. The roadway hazard detection and warning module of claim 18 wherein determining if an alert should be provided comprises determining if the standard vehicle is within a predetermined vehicle hazard distance of the one or more hazard vehicles.

20. The roadway hazard detection and warning module of claim 19 wherein the memory stores further instructions, which, when executed by the processing circuitry cause the roadway hazard detection and warning module to provide the alert if the standard vehicle is within the predetermined vehicle hazard distance of the one or more hazard vehicles.
